(19) United States
(12) Patent Application Publication
(10) Pub. No.: US 2018/0048029 A1
(43) Pub. Date: Feb. 15, 2018

(54) ELEMENT CONDUCTING SODIUM IONS FOR USE IN ELECTROCHEMICAL CELLS AND METHOD FOR PRODUCING IT

(71) Applicant: FRAUNHOFER-GESELLSCHAFT ZUR FOERDERUNG DER ANGEWANDTEN FORSCHUNG E.V., Muenchen (DE)

(72) Inventors: Jochen SCHILM, Redebeul (DE); Mihails KUSNEZOFF, Dresden (DE); Doerte WAGNER, Dresden (DE); Axel ROST, Dresden (DE)

(73) Assignee: FRAUNHOFER-GESELLSCHAFT ZUR FOERDERUNG DER ANGEWANDTEN FORSCHUNG E.V., Muenchen (DE)

(21) Appl. No.: 15/557,498

(22) PCT Filed: Mar. 10, 2016
(86) PCT No.: PCT/EP2016/055132

§ 371 Date: Sep. 12, 2017

(30) Foreign Application Priority Data
Mar. 12, 2015 (DE) 10 2015 204 465.3

(51) Int. Cl. H01M 10/39; H01M 2/14; C01F 7/02; C03C 8/08; C03C 4/18; H01M 2/16; C03C 3/097

(52) U.S. Cl. CPC H01M 10/3927; H01M 2/1646; H01M 2/1686; H01M 2/145; C03C 3/097; C03C 8/08; C03C 4/18; C01F 7/021

(57) ABSTRACT

The invention relates to sodium-ion-conducting elements for use in electrochemical cells, more particularly as solid electrolyte/separator in high-temperature batteries. In these elements, a surface of a porous substrate bears a coating which is obtained by sintering at a temperature of not more than 1100° C. and which is formed with the system Na₂O—SiO₂—R₂O₅—R1₂O₃, in which R1=Sc, Y, La and/or B and R2=P, Sb, Bi, Sn, Te, Zn and/or Ge.

The invention relates to sodium-ion-conducting elements for applications in electrochemical cells, having a ceramic, sodium-ion-conducting component which may be used as solid electrolyte and separator in, for example, high-temperature batteries (sodium-sulfur type or sodium-NiCl₂-ZEBRA battery). It likewise relates to a method for producing these elements.

Solid electrolytes of this kind are customarily produced from an Na-ion-conducting variant of Al₂O₃ ceramics (known as Na-beta-Al₂O₃), in the form of monolithic tubes which are closed on one side, using conventional ceramic technologies, such as pressing and sintering at high temperatures (1500° C.-1600° C.). There are various disadvantages affecting both the material used and the technology chain. While the ceramic raw materials used in principle can be provided easily and inexpensively, the sintering of these ceramic materials is connected with exacting requirements.
1. In order to achieve high ionic conductivity, a particular β-modification must be formed as far as possible in one phase during sintering, something which is realizable within limits only through particular admixtures/additives and boundary conditions during sintering.
2. The sintering of these ceramic materials requires temperatures of between 1500° C. and 1600° C. In view of the fact that the material contains highly mobile Na ions, these ions are volatile under sintering conditions and escape as vapor from the sinter bodies. This alters the stoichiometry and the ionic conductivity of the material, and there are corrosive reactions with the oven lining. This necessitates specific, costly and inconvenient, oven and sintering technologies.
3. The conductive beta-aluminate is not an unusually mechanically stable structural ceramic, since it does not have high specific strength. Accordingly, the tubes have to be made with appropriate wall thicknesses to achieve suitable stability. These boundary conditions are at the expense of the ion conductivity, which is in inverse proportion to the wall thickness. Low wall thicknesses of the solid electrolytes are necessary for a high power density of the electrochemical cell produced from it.
4. The large dimensions of the tubes mean that established ceramic pressing technologies (hot and cold) are close to their limits, and reliable production with no rejects is now virtually impossible. To date, alternative shaping methods (e.g., extrusion) have not achieved the required parameters (conductivity, strength) which can really be obtained with pressing processes.

There is therefore a search for possibilities for realizing extremely thin, hermetically sealing membranes which conduct sodium ions and which are able to provide more cost-effective, more reliable and more flexible production of the solid electrolytes/separators which are needed for the electrochemical cells, such as high-temperature batteries.

The sodium-sulfur-technology, as a basis for a high-temperature battery, has been known since the 1960s, when it was recognized that the compound NaAl₁₁O₁₇ becomes a sodium ion conductor at around 300° C. The efforts at ongoing development of the sodium-sulfur battery derive from factors including the comparatively high energy density, high efficiency, and high cycling stability of such a battery. Moreover, the materials used are more cost-effective by comparison, for example, with the lithium-ion technology. The technology of high-temperature sodium-sulfur batteries does have disadvantages, with the high operating temperature of around 300° C. occupying the top position. The self-discharge, however, is negligible. Account must be taken in particular of thermal losses in the event of prolonged service times. Other disadvantages are the high corrosiveness in association with liquid sodium, and the known sensitivity of the solid-state electrolytes to (atmospheric) moisture. The following requirements are simultaneously imposed on the electrolytes: high ion conductivity, low electronic conductivity, high density, mechanical stability, and insensitivity toward corrosion. The key cause of failure is generally the fracture of the ceramic electrolyte, associated with the risk of sudden exothermic reaction of sulfur with liquid sodium. The material currently considered in high-temperature sodium-sulfur batteries is the binary oxide Na-beta-Al₂O₃ (here also sodium aluminate), which may additionally be doped with other alkali metal and alkaline earth metal oxides. It functions simultaneously as polycrystalline solid-state electrolyte and separator, and is employed in the form of a nonstoichiometric compound ((1.0-1.6).Na₂O.(5-11)Al₂O₃).

With sodium-sulfur and sodium-NiCl₂ (ZEBRA) batteries of these kinds, the design used for a beta-Al₂O₃ solid electrolyte/separator is a tubular body which is open at one side, containing liquid sodium. NiCl₂ or sulfur is disposed outside of this body. In contradistinction to this conventional design mode, inverted arrangements ought to be possible in which the sulfur or the NiCl₂ salt is located in the interior of the ceramic tube and the sodium melt on the outside.

In the decades that have passed since the beginning of the studies in this field, little has changed in the half-side-closed tube embodiment.

Producing ceramic solid electrolytes in such forms as tubes closed on one side is accomplished by unaxial cold pressing and unpressurized sintering in air. One problem is the escape of sodium in vapor form under sintering conditions, and the associated change in the stoichiometry and the conductivity of the Na beta-aluminate phase. In order to maximize ion conductivity, it is necessary to realize as far as possible a one-phase material composed of the defined 3-phase (so-called (3″-phase). Additionally, the escaping sodium vapor causes corrosive reactions with oven components, in turn necessitating the use of a stable and very highly impervious oven lining made, for example, from spinel (MgAlO₄) or MgO.

Consequently, a large number of known technical solutions are based on this embodiment, which is also coupled inherently to the ceramic technologies already described. Employed normally in this context are monolithic ceramic components, fabricated exclusively from the sodium beta-aluminate material.

In deviation from this embodiment, there are technical solutions known in which a composite structure has been selected for a solid electrolyte. With this structure of a solid electrolyte, the function of the supporting component is taken on by a porous tube of alpha-aluminum oxide, which does not conduct sodium ions and which is closed on one side. This supporting component is provided on an outside with a 5 μm- to 500 μm-thick coating of dense sodium beta-aluminate.

Advantageous features of this embodiment are that the porous alpha-Al₂O₃ tube ensures high mechanical stability, and the thin Na-β-Al₂O₃ layer exhibits low resistance. It does not, however, fulfil any mechanical function. Accordingly, the internal resistance of an electrochemical cell constructed from this solid electrolyte can be lowered significantly. A disadvantage of this construction, which can in fact be realized in a plurality of steps, is that the beta-aluminate layer must likewise be sintered at temperatures above 1500° C. and is therefore subject to the same disadvantages, described above, as monolithic components made from this material. There is a likelihood of vaporous escape of sodium and also of interaction of the two materials during the sintering process. Consequently there is a risk of altered stoichiometry of the ion-conductive phase.

It is therefore an object of the invention to provide sodium-ion-conducting elements, such as solid electrolytes and/or separators for electrochemical applications, which exhibit high ionic conductivity that can be maintained reproducibly, which at the same time have sufficient mechanical strength, and for which production can be simplified and made more cost-effective.

A porous substrate functions as a mechanically stable membrane and can be fabricated as an individual component. The selection of materials here is not necessarily confined to Al₂O₃. Substrate material employed may also be other ceramic materials, such as, for example, mullite, spinel, forsterite, ZrO₂, or silicatic ceramic materials. The substrate may advantageously be produced using electronically conducting ceramic materials, such as Nb—TiO₂, Ca₁₋ₓLaₓTiO₃ or Sr₁₋ₓYₓTiO₃, for example, which exhibit high electron conduction (being what are called n-type conductors) at low oxygen partial pressures. Suitable conductive porous substrates may alternatively consist of a metal or a metal alloy. The electron conduction of the substrate is intended to help to transopt the electrons from the electrolyte surface to the current collector and thereby to facilitate the internal contacting of the electrochemically active regions of the cell.

One surface of the porous substrate bears a coating which conducts sodium ions. The sintered coating consists of a glass-ceramic material of the system (Na₂O—SiO₂—R2₂O₅—R1₂O₃; R1=Sc, Y, La and/or B and R2=P, Sb, Bi, Sn, Te, Zn and/or Ge). It is conceivable for other trivalent oxides of the type R1₂O₃ to be contemplated, in place of or as a supplement to the trivalent cations already stated, without substantially altering the conductivity. From certain compositions of this system it is possible to produce glass-ceramic materials which possess high proportions of sodium-ion-conducting crystal phases and have ion conductivities which at least are equivalent, and may also be superior, to those of commercial sodium beta-aluminate grades.

The compositions of the glass-ceramics ought in particular to be suitable for formation of a crystal phase having the stoichiometry Na₅R1Si₄O₁₂ (R1=Sc, Y, La and/or B), since this phase has particularly high specific conductivities. The additive R2₂O₅, that is able to take on the function of a sintering additive for separating the sintering process and the crystallization process. The additive used may preferably be P₂O₅. In addition to or instead of P₂O₅, it is also possible, as oxides with similar or identical effect, to use Sb₂O₃, Sb₂O₅, Bi₂O₃, SnO₂, TeO₂, ZnO, GeO₂.

Alternatively, the glass-ceramic coating may also be produced directly during the firing from a mixture of suitable pulverulent starting materials which correspond nominally to the composition of the glass ceramic and which, after firing, also have the same sodium-ion-conducting phase consistency. With regard to the starting materials used, the following exemplary possibilities are given:
mixture of the oxides from raw material powders in stoichiometric composition
glass powder having a composition different from the desired glass-ceramic, this powder producing a glass-ceramic with the target composition only through reaction with further, added pulverulent oxides and/or glass powders.

Furthermore, the mixture of the starting materials, as well as oxides and glasses, may also include salts or other compounds containing the cations in question.

The production of the conductive coating is based accordingly on powders or powder mixtures which can be converted, with admixing of further auxiliaries, after additional processing steps, into a form suitable for the application of coatings. Examples of such forms of application may be suspensions, which are generally characterized in that a pulverulent solid phase is dispersed uniformly in a liquid phase with or without further auxiliaries.

There are a large number of known methods by which such suspensions can be applied as coatings to solid surfaces. Examples here include screen printing, knifecoating, spray application, and dip coating. A skilled person is able to modify such suspensions in a suitable way such that other coating methods may also be contemplated. Application may also take place by means of plasma spraying.

In the formation of such a coating, free contraction and crystallization with glass-forming starting components may be achieved even at temperatures <1000° C. Accordingly it is possible to produce crystallized, sodium-ion-conductive elements even at processing temperatures below 1000° C. The sintered coating attains densities of more than 95% of the theoretical density and is therefore hermetically sealing, since it has only a closed porosity if any at all.

In the invention, a powder, having a suitable composition for the formation of conductive crystalline phases, can be processed to a paste or a suspension (slips) and thus the porous substrate can be coated with this paste or suspension on one surface—in other words, in the case of a porous body which is open on one side, from the inside or from the outside. When drying and debindering have taken place to remove organic components, this layer on the porous substrate may be fired.

The use of a crystallizing glass material comprising the system Na₂O—SiO₂—R2₂O₅—R1₂O₃ for the formation of the coating affords a variety of advantages:
1. A sintering temperature already sufficient at 1000° C. up to a maximum 1100° C. or below reduces the vaporous escape of Na₂O from the layer almost completely, allowing a target stoichiometry in relation to the desired crystal phases to be realized more effectively and maintained reproducibly.
2. Furthermore, because of the relatively low sintering temperature, there is a considerable reduction in unwanted side-reactions with the porous substrate material, relative to the temperature level of 1500° C. or more required to date.
3. The sintered application of a crystallizing glass layer in the system Na₂O—SiO₂—R2₂O₅—R1₂O₃ affords the advantage, moreover, that mechanical stresses can be removed by viscous flow of the molten glass, which has a positive effect on the crack-free status of the coating during production and the thermal cycling of the finished component in operation.

Production may take place using a powder having the following composition:

SiO₂ at a fraction of 47 mol % to 63 mol %, Na₂O at a fraction of 33 mol % to 43 mol %, R1₂O₃ at a fraction of 3 mol % to 14 mol %, and R2₂O₅ at a fraction of 0.1 mol % to 10 mol %. Here, R1 is yttrium, scandium, lanthanum and/or boron, and R2 is phosphorus, antimony, bismuth, tin, tellurium, zinc and/or germanium.

In order to prevent cracking in the coating, the coefficient of thermal expansion (α) of the porous substrate ought to differ only slightly (e.g., delta α<1.5 ppm/K) from that of the crystallized coating material. The coefficient of thermal expansion of the coating ought as far as possible to be lower than the coefficient of thermal expansion of the porous substrate, in order to maintain the coating under compressive stresses in the cooled state and in operation, and so to prevent cracking in the coating.

With the invention it is possible to achieve the following advantages and/or prevent the following disadvantages:
a. In comparison to thick, monolithic solid electrolytes/separators, it is possible to produce coatings on a stable substrate as support that are significantly thinner and yet gastight and ion-conductive; as a result, for comparable specific ion conductivity, the resulting absolute ion conductivity of the solid electrolyte/separator is correspondingly higher.
b. By using a porous yet stable and technologically established substrate to which the ion-conductive functional coating has been applied, the reject rate in production can be lowered by comparison with monolithic solid electrolytes made of pure beta-aluminate.
c. There is no need for pressing technology, since, for example, porous, nonconductive β-Al₂O₃ substrates, or substrates formed from other porous materials, especially tubes, can also be produced via more cost-effective casting processes or continuous extrusion processes. The coating of the porous substrate may also be accomplished via processes which can be carried out continuously and are therefore more cost-effective.
d. Because of the possibility of sintering an ion-conductive coating at a temperature of 1000° C. or below, it is possible to use a more cost-effective oven technology. There is also no need for additional firing aids, since at these temperatures there is no significant evaporation of sodium.

Below, the invention will be elucidated in more detail with examples.

### EXAMPLE 1

Melting of a mixture having the composition 53 mol % SiO₂, 38 mol % Na₂O, 6 mol % Y₂O₃, and 4 mol % P₂O₅ in a platinum crucible at 1500° C. for 2 h with subsequent fritting of the melt in water and subsequent drying at 150° C. for 12 h.
Preliminary grinding of the frit in an oscillatory disk mill provided with hard-metal lining, to an average particle diameter of about 125 μm after sieving.
Fine grinding of the resulting powder in an Attritor with ethanol as grinding medium to an average particle size of d₅₀=2 μm.
Preparation of this powder to form a paste having a solids content of 65 mass % using ethylcellulose as binder and terpineol as solvent.
Manual application of the paste as a layer with a plastic knife to a surface of a porous Al₂O₃ tube as substrate (porosity>40% pore diameter>1 μm).
Drying of the paste at 120° C. for 1 h in air.
Firing of the layer in air according to the following profile: RT-2 K/min-->450° C./1 h-2 K/min-->900° C./1 h-2 K/min-->RT.
After firing had been carried out, layer thicknesses between 150 μm and 250 μm were found via microscopic analyses on ground sections.
Measurements of the ion conductivity on a high-temperature measuring facility (in-house construction), using a salt melt (NaNO₃/NaNO₂) as liquid electrolyte, found the following specific conductivities.

| Temperature [° C.] | Conductivity [S cm⁻¹] |
|---|---|
| 230 | 0.051 |
| 250 | 0.059 |
| 275 | 0.071 |
| 300 | 0.085 |
| 310 | 0.091 |
| 320 | 0.095 |
| 330 | 0.11 |

### EXAMPLE 2

Melting of a mixture having the composition 53 mol % SiO₂, 38 mol % Na₂O, 6 mol % Y₂O₃, and 4 mol % P₂O₅ in a platinum crucible at 1500° C. for 2 h with subsequent fritting of the glass melt in water and drying at 150° C. for 12 h.
Preliminary grinding of the resulting frit in an oscillatory disk mill provided with hard-metal lining, to an average diameter of about 125 μm after sieving.
Fine grinding of the powder in an Attritor with ethanol as grinding medium to an average particle size of d₅₀=2 μm.
Preparation of this powder to form an aqueous slip (suspension) having a solids content of 70 mass % using commercial adjuvants as stabilizers and dispersants.
A porous Al₂O₃ tube as substrate closed at one end (porosity>40%, pore diameter>1 μm) is dipped into the slip, so that the open end of the substrate protrudes from the slip and the outer surface of the tube is coated with the slip.
A vacuum with a reduced pressure of 1 mbar-10 mbar with respect to atmospheric pressure is then applied to the open end of the tube and maintained for 10 minutes. As a result, the suspension is drawn under suction into the interior of the tube, and particles are deposited as a layer on the outer surface.
Drying of the Al₂O₃ tube coated in this way on the outward-facing surface at 150° C. in air for 15 h.
Sintering of the layer in air according to the following profile:
RT-2 K/min-->450° C./1 h-2 K/min-->900° C./1 h-2 K/min-->RT.
After firing had been carried out, layer thicknesses between 400 μm and 700 μm were found via microscopic analyses on ground sections.
Measurements of the ion conductivity on a high-temperature measuring facility (in-house construction), using a salt melt (NaNO₃/NaNO₂) as liquid electrolyte, found the following specific conductivities.

| Temperature [° C.] | Conductivity [S cm⁻¹] |
|---|---|
| 230 | 0.049 |
| 250 | 0.058 |
| 275 | 0.069 |
| 300 | 0.084 |
| 310 | 0.089 |
| 320 | 0.093 |
| 330 | 0.10 |

1. A sodium-ion-conducting element for use in electrochemical cells, more particularly as solid electrolyte/separator in high-temperature batteries, wherein a surface of a porous substrate bears a coating which is obtained by sintering at a temperature of not more than 1100° C. and which is formed with the system Na₂O—SiO₂—R₂O₅—R1₂O₃, in which R1=Sc, Y, La and/or B and R2=P, Sb, Bi, Sn, Te, Zn and/or Ge.

2. The element as claimed in claim 1, characterized in that the coating has a thickness in the 3 μm to 750 μm range.

3. The element as claimed in claim 1, characterized in that the material of the coating has a coefficient of thermal expansion which is lower, preferably lower by not more than 1.5 ppm/K, than the coefficient of thermal expansion of the substrate material.

4. The element as claimed in claim 1, characterized in that the substrate is an element in the shape of a plate, honeycomb, or tube which is open at one side.

5. The element as claimed in claim 1, characterized in that the substrate is formed of Al₂O₃, mullite, spinel, fosterite, ZrO₂, a silicatic ceramic material, an electrically conducting ceramic material, or a metal or a metal alloy.

6. The element as claimed in claim 1, characterized in that electrically conducting ceramic substrate material consists of Nb-doped TiO₂, Ca₁₋ₓLaₓTiO₃ or Sr₁₋ₓYₓTiO₃ or of a mixture of these components with Al₂O₃, mullite, spinel, fosterite, ZrO₂ or a silicatic ceramic material.

7. The element as claimed in claim 1, characterized in that the substrate has a porosity in the 30% to 80% range.

8. The element as claimed in claim 1, characterized in that the coating has a density which is above 95% of the theoretical density after sintering.

9. A method for producing an element as claimed in claim 1, characterized in that a powder formed with SiO₂ at a fraction of 47 mol % to 63 mol %, Na₂O at a fraction of 33 mol % to 43 mol %, R1₂O₃ at a fraction of 3 mol % to 14 mol %, and R2₂O₅ at a fraction of 0.1 mol % to 10 mol %, in the form of a paste or suspension comprising this powder, to a surface of the porous substrate, which as a layer is applied and then, to form a coating on the surface of the substrate, sintering is carried out at a temperature of not more than 1100° C., where R1 is scandium, yttrium, lanthanum and/or boron and R2 is phosphorus, antimony, bismuth, tin, tellurium, zinc and/or germanium.

10. The method as claimed in claim 9, characterized in that the layer is formed by knife coating, spraying, dipping, plasma spraying or by vacuum slip casting on the surface of the substrate prior to sintering.
